(19) United States
(12) Patent Application Publication
(10) Pub. No.: US 2025/0113844 A1
(43) Pub. Date: Apr. 10, 2025

(54) GAS LOSS REDUCING ADDITIVE FOR BEVERAGES, A BEVERAGE COMPOSITION INCLUDING THE GAS LOSS REDUCING ADDITIVE AND A METHOD OF REDUCING GAS LOSS FROM A BEVERAGE

(71) Applicant: Givaudan SA, VERNIER (CH)

(72) Inventors: Irma Leticia GONZALEZ, Mexico City (MX); Milena FRANCO, Bogota (CO)

(21) Appl. No.: 18/832,337

(22) PCT Filed: Feb. 1, 2023
(86) PCT No.: PCT/EP2023/052424

§ 371 Date: Jul. 23, 2024

Related U.S. Application Data
(60) Provisional application No. 63/307,015, filed on Feb. 4, 2022.

(51) Int. Cl. A23L 2/54

(52) U.S. Cl. CPC A23L 2/54

(57) ABSTRACT

A method of reducing gas loss from a beverage, such as a reduced sugar or no sugar carbonated beverage, by encapsulating at least a portion of the gas bubbles present in the beverage to reduce or prevent loss of gas from the beverage. A reduced sugar or no sugar carbonated beverage including a carbonated beverage base and an additive that encapsulates at least a portion of the gas bubbles present in the beverage for the purpose of reducing or preventing loss of gas from the beverage. Use of a glyceride in a reduced sugar or no sugar carbonated beverage to encapsulate at least a portion of the gas bubbles present in the beverage thereby reducing or preventing loss of gas from the beverage.

This is a Provisional Application For Patent under 35 U.S.C. § 119(e).

### TECHNICAL FIELD

The present disclosure relates to a gas loss reducing additive for a beverage, a method for reducing gas loss from a beverage, and a beverage including the gas loss reducing additive. The present disclosure more particularly relates to a gas loss reducing additive for a carbonated beverage, a method for reducing gas loss from a carbonated beverage, and a carbonated beverage including the gas loss reducing additive.

### BACKGROUND

Carbonated beverages contain a flavor, a sweetener, water, and carbon dioxide gas dissolved in the water of the beverage. Because carbon dioxide gas is only slightly soluble in water, the carbonated beverage must be kept under high pressure to maintain the carbon dioxide gas dissolved in the water medium the beverage. When the pressure is removed from the beverage the carbon dioxide gas is released as small bubbles which float to the surface of the beverage and create an effervescence or fizz in the beverage.

Many carbonated beverages include nutritive sweeteners such as sucrose or high fructose corn syrup to impart sweetness and a full mouthfeel to the carbonated beverage. However, there is an ongoing effort in the beverage industry to replace at least a portion of the nutritive sweetener sucrose with a non-nutritive sweetener in order to reduce the overall caloric content of a beverage while mimicking the sweet taste and mouth feel of a full sugar beverage. These beverages are often referred to as reduced sugar, low sugar, no sugar, or zero sugar beverages.

Many non-nutritive sweeteners, such as aspartame, acesulfame potassium, sodium cyclamate, stevia, saccharin and sucralose have a lower solubility in a beverage medium. When sugar is partially or entirely replaced with one or more non-nutritive sweeteners to create a reduced sugar or zero sugar beverage there is an associated change in the density of the beverage. The density of reduced sugar or zero sugar carbonated beverages results in greater carbon dioxide gas loss from the beverage as compared to the gas loss from a full sugar carbonated beverage.

In a reduced sugar or zero sugar carbonated beverage the small carbon dioxide gas bubbles in the beverage are attracted to one another and combine into larger bubbles that rise to the surface of the beverage causing excessive foaming and loss of carbon dioxide gas from the beverage, as compared to a full sugar beverage. This results in the loss of effervescence and fizz from the beverage, making the beverage less palatable to a consumer for consumption. Moreover, carbonated beverages must be filled into suitable containers for sale and the excessive foaming of reduced sugar or zero sugar beverages complicates and slows the filling process.

Thus, there remains a need in the beverage art to develop additives for reduced sugar or zero sugar carbonated beverages that are sweetened with non-nutritive sweeteners to better mimic the sweet taste, mouthfeel, and gas retention properties of full sugar carbonated beverages.

### SUMMARY OF ILLUSTRATIVE EMBODIMENTS

Provided is a method for reducing gas loss from a carbonated beverage, the method comprising adding at least one gas loss reducing additive to the carbonated beverage in amount sufficient to encapsulate at least a portion of the gas bubbles present within the carbonated beverage.

Further provided is a method for reducing gas loss from a reduced sugar carbonated beverage, the method comprising adding at least one gas loss reducing additive to the reduced sugar carbonated beverage in amount sufficient to encapsulate at least a portion of the gas bubbles present within the reduced sugar carbonated beverage.

Further provided is a method for reducing gas loss from a zero sugar carbonated beverage, the method comprising adding at least one gas loss reducing additive to the zero sugar carbonated beverage in amount sufficient to encapsulate at least a portion of the gas bubbles present within the zero sugar carbonated beverage.

Further provided is a method for reducing gas loss from a carbonated beverage, the method comprising adding at least one glyceride to the carbonated beverage in amount sufficient to encapsulate at least a portion of the gas bubbles present within the carbonated beverage.

Further provided is a method for reducing gas loss from a reduced sugar carbonated beverage, the method comprising adding at least one glyceride to the reduced sugar carbonated beverage in amount sufficient to encapsulate at least a portion of the gas bubbles present within the reduced sugar carbonated beverage.

Further provided is a method for reducing gas loss from a zero sugar carbonated beverage, the method comprising adding at least one glyceride to the zero sugar carbonated beverage in amount sufficient to encapsulate at least a portion of the gas bubbles present within the zero sugar carbonated beverage.

Further provided is a carbonated beverage comprising a beverage base and at least one gas loss reducing additive in an amount sufficient to encapsulate at least a portion of the gas bubbles present within the carbonated beverage.

Further provided is a reduced sugar carbonated beverage comprising a beverage base and at least one gas loss reducing additive in an amount sufficient to encapsulate at least a portion of the gas bubbles present within the reduced sugar carbonated beverage.

Further provided is a zero sugar carbonated beverage comprising a beverage base and at least one gas loss reducing additive in an amount sufficient to encapsulate at least a portion of the gas bubbles present within the zero sugar carbonated beverage.

Further provided is a carbonated beverage comprising a beverage base and at least one glyceride in an amount sufficient to encapsulate at least a portion of the gas bubbles present within the carbonated beverage.

Further provided is a reduced sugar carbonated beverage comprising a beverage base and at least one glyceride in an amount sufficient to encapsulate at least a portion of the gas bubbles present within the reduced sugar carbonated beverage.

Further provided is a zero sugar carbonated beverage comprising a beverage base and at least one glyceride in an amount sufficient to encapsulate at least a portion of the gas bubbles present within the zero sugar carbonated beverage.

Further provided is the use of a gas loss reducing additive in a carbonated beverage to reduce gas loss from the carbonated beverage.

Further provided is the use of a gas loss reducing additive in a reduced sugar carbonated beverage to reduce gas loss from the reduced sugar carbonated beverage.

Further provided is the use of a gas loss reducing additive in a zero sugar carbonated beverage to reduce gas loss from the zero sugar carbonated beverage.

Further provided is the use of a glyceride in a carbonated beverage to reduce gas loss from the carbonated beverage.

Further provided is the use of a glyceride in a reduced sugar carbonated beverage to reduce gas loss from the reduced sugar carbonated beverage.

Further provided is the use of a glyceride in a zero sugar carbonated beverage to reduce gas loss from the zero sugar carbonated beverage.

### DETAILED DESCRIPTION OF ILLUSTRATIVE EMBODIMENTS

The following text sets forth a broad description of numerous different embodiments of the present disclosure. The description is to be construed as illustrative only and does not describe every possible embodiment since describing every possible embodiment would be impractical, if not impossible. It will be understood that any feature, characteristic, component, composition, ingredient, product, step, or methodology described herein can be deleted, combined with, or substituted for, in whole or part, any other feature, characteristic, component, composition, ingredient, product, step, or methodology described herein. Numerous alternative embodiments could be implemented, using either current technology or technology developed after the filing date of this patent application, which would still fall within the scope of the claims.

Each of the terms “comprises,” “comprising,” “comprised of,” “has,” “having,” “includes,” “including,” “contains,” “containing,” or any other variation are open-ended terms and are intended to cover a non-exclusive inclusion of elements, features, or steps, such that an article, apparatus, compound, composition, combination, method, or process that “comprises,” “has,” or “includes,” or “contains” a recited list of elements or steps does not include only those elements or steps, but may include other elements or steps not expressly listed, recited, or written in the specification or claims. An element or feature proceeded by the language “comprises . . . a,” “contains . . . a,” “has . . . a,” or “includes . . . a” does not, without more constraints, preclude the existence or inclusion of additional elements or features in the article, apparatus, compound, composition, combination, method, or process that comprises, contains, has, or includes the element or feature.

The terms “a” and “an” are defined as one or more unless expressly stated otherwise or constrained by other language herein. An element or feature proceeded by “a” or “an” may be interpreted as one of the recited element or feature, or more than one of the element or feature.

The terms “about,” “approximately,” “essentially,” “substantially,” any other variation or version thereof, or any other similar relative term, or similar term of approximation, are defined as being close to as understood by one having ordinary skill in the art. By way of non-limiting, illustrative embodiments, the terms “about,” “approximately,” “essentially,” “substantially,” any other variation or version thereof, or any other similar relative term, or similar term of approximation, are defined to be within 20% of a recited value, or defined to be within 10% of a recited value, or defined to be within 5% of a recited value, or defined to be within 4% of a recited value, or defined to be within 3% of a recited value, or defined to be within 2% of a recited value, or defined to be within 1% of a recited value, or defined to be within 0.5% of a recited value, or defined to be within 0.25% of a recited value, or defined to be within 0.1% of a recited value.

It should be understood that when an amount in weight percent is described in the present disclosure, it is intended that any and every amount within the range, including the end points, is to be considered as having been expressly disclosed. For example, the disclosure of “a range of from about 1 weight percent to about 10 weight percent” is to be read as indicating each and every possible number along the continuum between about 1 and about 10. It is to be understood that the inventors appreciate and understand that any and all data points within the range are to be considered to have been disclosed, and that the inventors have possession of the entire range and all points within the range.

When a concentration is expressed as “ppm” in the present disclosure, the concentration is parts per million by weight based on the total weight of the beverage. It should be understood that when a range of ppm values is described in the present disclosure, it is intended that any and every value within the range, including the end points, is to be considered as having been disclosed. For example, “a range of from about 1 ppm to about 1000 ppm” of a component of the composition is to be read as indicating each and every possible number along the continuum between 1 and 1000. It is to be understood that the inventors appreciate and understand that any and all values within the range are to be considered to have been specified, and that the inventors have possession of the entire range and all the values within the range.

For the avoidance of doubt, preferences, options, particular features and the like indicated for a given aspect, feature or parameter of the disclosure should, unless the context indicates otherwise, be regarded as having been disclosed in combination with any and all other preferences, options, particular features and the like as indicated for the same or other aspects, features and parameters of the invention.

The term “nutritive sweetener” refers to sweeteners that provide caloric content to a beverage when used in its typical concentration.

The term “non-nutritive sweetener” refers to all sweeteners other than nutritive sweeteners and do not provide any caloric content to a beverage.

Due to the low solubility of non-nutritive sweeteners in carbonated beverages as compared to sucrose, a decrease in surface tension is generated that favors the migration of large carbon dioxide bubbles to the surface of the carbonate beverage, the formation of a foam, loss of gas from the beverage medium, and decrease in the sensation of carbonation. The additive for a carbonated beverage that is capable of reducing the amount of dissolved carbon dioxide gas that is lost from the carbonated beverage. The gas loss reducing additive promotes retention of the dissolved carbon dioxide gas by encapsulating carbon dioxide gas bubbles present within the carbonated beverage. The encapsulation of the carbon dioxide bubbles results in an increase in the surface tension of the carbon dioxide gas bubbles present within the beverage. The increased surface tension of the gas bubbles reduces the ability of the gas bubbles to aggregate into larger gas bubbles that rise the surface of the beverage and foam. The increased surface tension reduces foaming and promotes retention of the carbon dioxide gas within the beverage. The inclusion of the gas loss reducing additive enables the carbonated beverage to retain an effervescent and fizzy carbonation perception for a longer period of time as compared to a reduced or zero sugar carbonated beverage of the same composition but without the inclusion of the gas loss reducing additive.

According to certain illustrative embodiments, the gas loss reducing additive encapsulates carbon dioxide bubbles by forming a film on the outer surface of carbon dioxide bubbles present in the carbonated beverage. According to certain illustrative embodiments, the gas loss reducing additive encapsulates carbon dioxide bubbles by forming a continuous film on the outer surface of carbon dioxide bubbles present in the carbonated beverage. According to certain illustrative embodiments, the gas loss reducing additive encapsulates carbon dioxide bubbles by forming a viscoelastic film on the outer surface of carbon dioxide bubbles present in the carbonated beverage.

The gas loss reducing additive comprises at least one monoglyceride, at least one diglyceride, or a combination of at least one monoglyceride and at least one diglyceride. A glyceride (also known as an acylglycerol) is an ester of a fatty acid and glycerol. A glyceride is formed by a covalent bond between a fatty acid group and one, two, or three of the hydroxyl groups of the glycerol compound. This covalent bond is referred to as the acylglycerol bond or acylglycerol linkage.

Glycerides useful in the present disclosure may vary in their chemical structure based on the number of carbon atoms in the fatty acid group, and/or the different degrees of unsaturation of the fatty acid groups, and/or the different configurations of the fatty acid groups. The fatty acids useful in the present disclosure include short chain fatty acids having an aliphatic chain with 5 or less carbon atoms, medium chain fatty acids having an aliphatic chain with 6 to 12 carbon atoms, long chain fatty acids having an aliphatic chain with 13 to 21 carbon atoms, and very long chain fatty acids having an aliphatic chain with 22 or more carbon atoms. The aliphatic chains of the fatty acids may be saturated (no carbon-carbon double bonds in the aliphatic chain) or unsaturated (having one or more carbon-carbon double bonds in the aliphatic chain). The unsaturated fatty acids useful in the present disclosure may include both cis and trans configurations.

The at least one monoglyceride may be selected from a 1-acylglycerol of the following formula:

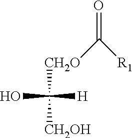

wherein R₁ a straight chain or branch chain, saturated or unsaturated, aliphatic hydrocarbon chain having at least 3 carbon atoms. According to certain illustrative embodiments, R₁ is a straight chain or branch chain, saturated or unsaturated, aliphatic chain having at least 5 carbon atoms. According to certain illustrative embodiments, R₁ is a straight chain or branch chain, saturated or unsaturated, aliphatic chain having from 6 to 12 carbon atoms. According to certain illustrative embodiments, R₁ is a straight chain or branch chain, saturated or unsaturated, aliphatic chain having from 13 to 21 carbon atoms. According to certain illustrative embodiments, R₁ is a straight chain or branch chain, saturated or unsaturated, aliphatic chain having from 22 to 28 carbon atoms.

The at least one monoglyceride may be selected from a 2-acylglycerol of the following formula:

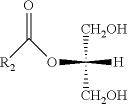

wherein R₂ a straight chain or branch chain, saturated or unsaturated, aliphatic hydrocarbon chain having at least 3 carbon atoms. According to certain illustrative embodiments, R₂ is a straight chain or branch chain, saturated or unsaturated, aliphatic chain having at least 5 carbon atoms. According to certain illustrative embodiments, R₂ is a straight chain or branch chain, saturated or unsaturated, aliphatic chain having from 6 to 12 carbon atoms. According to certain illustrative embodiments, R₂ is a straight chain or branch chain, saturated or unsaturated, aliphatic chain having from 13 to 21 carbon atoms. According to certain illustrative embodiments, R₂ is a straight chain or branch chain, saturated or unsaturated, aliphatic chain having from 22 to 28 carbon atoms.

The at least one monoglyceride may be selected from a 3-acylglycerol of the following formula:

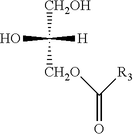

wherein R₃ a straight chain or branch chain, saturated or unsaturated, aliphatic hydrocarbon chain having at least 3 carbon atoms. According to certain illustrative embodiments, R₃ is a straight chain or branch chain, saturated or unsaturated, aliphatic chain having at least 5 carbon atoms. According to certain illustrative embodiments, R₃ is a straight chain or branch chain, saturated or unsaturated, aliphatic chain having from 6 to 12 carbon atoms. According to certain illustrative embodiments, R₃ is a straight chain or branch chain, saturated or unsaturated, aliphatic chain having from 13 to 21 carbon atoms. According to certain illustrative embodiments, R₃ is a straight chain or branch chain, saturated or unsaturated, aliphatic chain having from 22 to 28 carbon atoms.

The at least one diglyceride may be selected from a 1,2-diacylglycerol of the following formula:

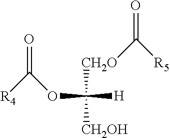

wherein each of R₄ and R₅ are independently a straight chain or branch chain, saturated or unsaturated, aliphatic hydrocarbon chain having at least 3 carbon atoms. According to certain illustrative embodiments, each of R₄ and R₅ are independently a straight chain or branch chain, saturated or unsaturated, aliphatic chain having at least 5 carbon atoms. According to certain illustrative embodiments, each of R₄ and R₅ are independently a straight chain or branch chain, saturated or unsaturated, aliphatic chain having from 6 to 12 carbon atoms. According to certain illustrative embodiments, each of R₄ and R₅ are independently a straight chain or branch chain, saturated or unsaturated, aliphatic chain having from 13 to 21 carbon atoms. According to certain illustrative embodiments, each of R₄ and R₅ are independently straight chain or branch chain, saturated or unsaturated, aliphatic chain having from 22 to 28 carbon atoms.

The at least one diglyceride may be selected from a 2,3-diacylglycerol of the following formula:

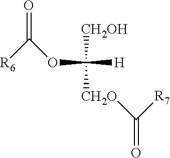

wherein each of R₆ and R₇ are independently a straight chain or branch chain, saturated or unsaturated, aliphatic hydrocarbon chain having at least 3 carbon atoms. According to certain illustrative embodiments, each of R₆ and R₇ are independently a straight chain or branch chain, saturated or unsaturated, aliphatic chain having at least 5 carbon atoms. According to certain illustrative embodiments, each of R₆ and R₇ are independently a straight chain or branch chain, saturated or unsaturated, aliphatic chain having from 6 to 12 carbon atoms. According to certain illustrative embodiments, each of R₆ and R₇ are independently a straight chain or branch chain, saturated or unsaturated, aliphatic chain having from 13 to 21 carbon atoms. According to certain illustrative embodiments, each of R₆ and R₇ are independently straight chain or branch chain, saturated or unsaturated, aliphatic chain having from 22 to 28 carbon atoms.

The at least one diglyceride may be selected from a 1,3-diacylglycerol of the following formula:

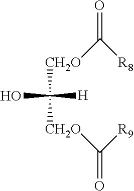

wherein each of R₈ and R₉ are independently a straight chain or branch chain, saturated or unsaturated, aliphatic hydrocarbon chain having at least 3 carbon atoms. According to certain illustrative embodiments, each of R₈ and R₉ are independently a straight chain or branch chain, saturated or unsaturated, aliphatic chain having at least 5 carbon atoms. According to certain illustrative embodiments, each of R₈ and R₉ are independently a straight chain or branch chain, saturated or unsaturated, aliphatic chain having from 6 to 12 carbon atoms. According to certain illustrative embodiments, each of R₈ and R₉ are independently a straight chain or branch chain, saturated or unsaturated, aliphatic chain having from 13 to 21 carbon atoms. According to certain illustrative embodiments, each of R₈ and R₉ are independently straight chain or branch chain, saturated or unsaturated, aliphatic chain having from 22 to 28 carbon atoms.

According to certain illustrative embodiments, each of R₁-R₉ may independently be substituted with other atoms such as, for example, oxygen, nitrogen and sulfur atoms, or other hydrocarbon groups.

According to certain illustrative embodiments, the gas loss reducing additive for the carbonated beverages comprises a blend of at least one monoglyceride and at least one diglyceride comprising from about 40 weight percent to about 60 weight percent of the at least one monoglyceride and from about 60 weight percent to about 40 weight percent of the at least one diglyceride.

According to certain illustrative embodiments, the gas loss reducing additive for the carbonated beverages comprises a blend of monoglycerides and diglycerides comprising from about 40 weight percent to about 60 weight percent of monoglycerides and from about 60 weight percent to about 40 weight percent of diglycerides. According to certain illustrative embodiments, the gas loss reducing additive for the carbonated beverages comprises a blend of monoglycerides and diglycerides comprising from about 46 weight percent to about 56 weight percent of monoglycerides and from about 54 weight percent to about 44 weight percent of diglycerides. According to certain illustrative embodiments, the gas loss reducing additive for the carbonated beverages comprises a blend of monoglycerides and diglycerides comprising from about 40 weight percent to about 60 weight percent of monoglycerides and from about 60 weight percent to about 40 weight percent of diglycerides, and comprising at least one of C14-C18 and C16-C18 unsaturated alkyl (monoglycerides) and at least one C14-C18 and C16-C18 unsaturated dialkyl glyceride (diglycerides). According to certain illustrative embodiments, the gas loss reducing additive for the carbonated beverages comprises a blend of monoglycerides and diglycerides comprising from about 46 weight percent to about 56 weight percent of monoglycerides and from about 54 weight percent to about 44 weight percent of diglycerides, and comprising at least one of C14-C18 and C16-C18 unsaturated alkyl (monoglycerides) and at least one C14-C18 and C16-C18 unsaturated dialkyl glyceride (diglycerides).

According to certain illustrative embodiments, the gas loss reducing additive for the carbonated beverages comprises a blend of at least one monoglyceride and at least one diglyceride comprising from about 40 weight percent to about 60 weight percent of the at least one monoglyceride and from about 60 weight percent to about 40 weight percent of the at least one diglyceride, and wherein the monoglyceride comprises the following formula:

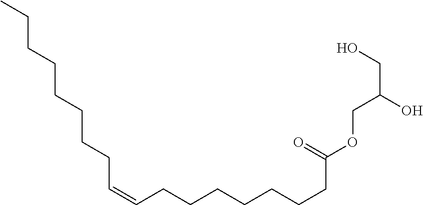 [SMILES: CCCCCCCC/C=C\CCCCCCCC(=O)OCC(O)CO]

According to certain illustrative embodiments, the gas loss reducing additive is provided in the form of spray-dried particles or powder suitable for addition to a liquid carbonated beverage. According to certain illustrative embodiments the gas loss reducing additive may be prepared by forming an oil in water emulsion containing at least one glyceride, water and an emulsifier and drying the emulsion. Without limitation, and only by way of illustration, the emulsion maybe dried by one of spray drying, spray granulation, or spray coating to obtain a dry emulsion. The emulsify may be selected from natural and synthetic antioxidants. Synthetic antioxidants include, for example, tert-Butylhydroquinone (TBHQ), methylparaben (MP), ethylparaben (EP), propylparaben (PP), butylparaben (BP), butylated hydroxyanisole (BHA), butylated hydroxytoluene (BHT), alpha-tocopherol (alpha-t) and alpha-tocopherol acetate (alpha-ta).

According to certain illustrative embodiments, also disclosed is a beverage comprising a beverage base and the additive for reducing gas loss from the beverage. According to certain illustrative embodiments, the beverage is a carbonated beverage comprising a beverage base, carbon dioxide gas to impart carbonation to the beverage, and the additive for reducing gas loss from the carbonated beverage. According to certain illustrative embodiments, the carbonated beverage is selected from reduced sugar carbonated beverages and zero sugar carbonated beverages comprising a beverage base, carbon dioxide gas to impart carbonation to the beverage, and the additive for reducing gas loss from the reduced sugar or zero sugar carbonated beverage. For the illustrative embodiments that are directed to a reduced sugar carbonated beverage, an amount of the nutritive sweetener such as sucrose is partially replaced with an amount a non-nutritive sweetener. For the illustrative embodiments that are directed to a zero sugar or no sugar carbonated beverage, an amount of the nutritive sweetener such as sucrose is wholly replaced with an amount a non-nutritive sweetener such that there is substantially no nutritive sweetener present in the zero sugar or no sugar carbonated beverage.

According to certain illustrative embodiments, also disclosed is a beverage comprising a beverage base and the additive for preventing gas loss from the beverage. According to certain illustrative embodiments, the beverage is a carbonated beverage comprising a beverage base, carbon dioxide gas to impart carbonation to the beverage, and the additive for preventing gas loss from the carbonated beverage. According to certain illustrative embodiments, the carbonated beverage is selected from reduced sugar carbonated beverages and zero sugar carbonated beverages comprising a beverage base, carbon dioxide gas to impart carbonation to the beverage, and the additive for preventing gas loss from the reduced sugar or zero sugar carbonated beverage.

For the illustrative embodiments that are directed to a reduced sugar carbonated beverage, an amount of the nutritive sweetener such as sucrose is partially replaced with an amount a non-nutritive sweetener.

For the illustrative embodiments that are directed to a zero sugar or no sugar carbonated beverage, an amount of the nutritive sweetener such as sucrose is wholly replaced with an amount a non-nutritive sweetener such that there is substantially no nutritive sweetener present in the zero sugar or no sugar carbonated beverage.

The carbonated beverage, whether the carbonated beverage is a reduced sugar or zero sugar beverage composition, comprises a beverage base and a sufficient amount of the gas loss reducing additive to reduce or prevent the loss of dissolved carbon dioxide gas from the beverage. As used herein, the term “beverage base” refers to water, a flavor, a sweetener, and all other ingredients desired or necessary for a complete beverage, apart from the gas loss reducing additive. These will naturally vary in both nature and proportion, depending on the nature and use of the consumable or additive, but they are all well known to the art and may be used in art-recognized proportions. The formulation of such a beverage base for every conceivable purpose is therefore within the ordinary skill of the art.

Carbon dioxide gas is dissolved in the beverage base to provide a desired level of carbonation to create a carbonated beverage. Any of the methods and carbonating equipment for known in the art for carbonating beverages may be used. According to certain illustrative embodiments, by way of example, and not in limitation, the beverage may have a carbon dioxide level in the range of about 0.5 to about 5 volumes of carbon dioxide. According to other embodiments, the beverage may have a carbon dioxide level of up to about 1 volume of carbon dioxide, or up to about 2 volumes of carbon dioxide, or up to about 3 volumes of carbon dioxide, or up to about 4 volumes of carbon dioxide. As used herein, one volume of carbon dioxide refers to the amount of carbon dioxide absorbed by a given quantity of liquid, such as water, at 60° F. and one atmospheric pressure. A volume of gas occupies the same space as does the liquid by which it is dissolved. The carbon dioxide content can be selected by those skilled in the art based on the desired level of effervescence and the impact of the carbon dioxide on the taste or mouthfeel of the beverage.

The gas loss reducing additive is added to the beverage base of the carbonated beverage to provide a carbonated beverage with the ability to retain a greater amount of dissolved carbon dioxide gas within the beverage for a longer period of time. The gas loss reducing additive may be included in the beverage base into which the carbon dioxide gas is dissolved. According to alternative illustrative embodiments, the gas loss reducing additive mat be separately added to the beverage base at the time the carbonated beverage is prepared.

The carbonated beverage includes at least one glyceride. The glyceride may vary in their chemical structure based on the number of carbon atoms in the fatty acid group, and/or the different degrees of unsaturation of the fatty acid groups, and/or the different configurations of the fatty acid groups. The fatty acids useful in the present disclosure include short chain fatty acids having an aliphatic chain with 5 or less carbon atoms, medium chain fatty acids having an aliphatic chain with 6 to 12 carbon atoms, long chain fatty acids having an aliphatic chain with 13 to 21 carbon atoms, and very long chain fatty acids having an aliphatic chain with 22 or more carbon atoms. The aliphatic chains of the fatty acids may be saturated (no carbon-carbon double bonds in the aliphatic chain) or unsaturated (having one or more carbon-carbon double bonds in the aliphatic chain). The unsaturated fatty acids useful in the present disclosure may include both cis and trans configurations.

According to illustrative embodiments, the carbonated beverage contains a sufficient amount of at least one monoglyceride selected from a 1-acylglycerol of the following formula:

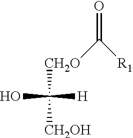

wherein R₁ a straight chain or branch chain, saturated or unsaturated, aliphatic hydrocarbon chain having at least 3 carbon atoms. According to certain illustrative embodiments, R₁ is a straight chain or branch chain, saturated or unsaturated, aliphatic chain having at least 5 carbon atoms. According to certain illustrative embodiments, R₁ is a straight chain or branch chain, saturated or unsaturated, aliphatic chain having from 6 to 12 carbon atoms. According to certain illustrative embodiments, R₁ is a straight chain or branch chain, saturated or unsaturated, aliphatic chain having from 13 to 21 carbon atoms. According to certain illustrative embodiments, R₁ is a straight chain or branch chain, saturated or unsaturated, aliphatic chain having from 22 to 28 carbon atoms.

According to illustrative embodiments, the carbonated beverage contains a sufficient amount of at least one monoglyceride selected from a 2-acylglycerol of the following formula:

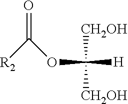

wherein R₂ a straight chain or branch chain, saturated or unsaturated, aliphatic hydrocarbon chain having at least 3 carbon atoms. According to certain illustrative embodiments, R₂ is a straight chain or branch chain, saturated or unsaturated, aliphatic chain having at least 5 carbon atoms. According to certain illustrative embodiments, R₂ is a straight chain or branch chain, saturated or unsaturated, aliphatic chain having from 6 to 12 carbon atoms. According to certain illustrative embodiments, R₂ is a straight chain or branch chain, saturated or unsaturated, aliphatic chain having from 13 to 21 carbon atoms. According to certain illustrative embodiments, R₂ is a straight chain or branch chain, saturated or unsaturated, aliphatic chain having from 22 to 28 carbon atoms.

According to illustrative embodiments, the carbonated beverage contains a sufficient amount of at least one monoglyceride selected from a 3-acylglycerol of the following formula:

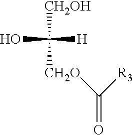

wherein R₃ a straight chain or branch chain, saturated or unsaturated, aliphatic hydrocarbon chain having at least 3 carbon atoms. According to certain illustrative embodiments, R₃ is a straight chain or branch chain, saturated or unsaturated, aliphatic chain having at least 5 carbon atoms. According to certain illustrative embodiments, R₃ is a straight chain or branch chain, saturated or unsaturated, aliphatic chain having from 6 to 12 carbon atoms. According to certain illustrative embodiments, R₃ is a straight chain or branch chain, saturated or unsaturated, aliphatic chain having from 13 to 21 carbon atoms. According to certain illustrative embodiments, R₃ is a straight chain or branch chain, saturated or unsaturated, aliphatic chain having from 22 to 28 carbon atoms.

According to illustrative embodiments, the carbonated beverage contains a sufficient amount of at least one diglyceride selected from a 1,2-diacylglycerol of the following formula:

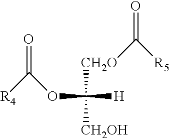

wherein each of R₄ and R₅ are independently a straight chain or branch chain, saturated or unsaturated, aliphatic hydrocarbon chain having at least 3 carbon atoms. According to certain illustrative embodiments, each of R₄ and R₅ are independently a straight chain or branch chain, saturated or unsaturated, aliphatic chain having at least 5 carbon atoms. According to certain illustrative embodiments, each of R₄ and R₅ are independently a straight chain or branch chain, saturated or unsaturated, aliphatic chain having from 6 to 12 carbon atoms. According to certain illustrative embodiments, each of R₄ and R₅ are independently a straight chain or branch chain, saturated or unsaturated, aliphatic chain having from 13 to 21 carbon atoms. According to certain illustrative embodiments, each of R₄ and R₅ are independently straight chain or branch chain, saturated or unsaturated, aliphatic chain having from 22 to 28 carbon atoms.

According to illustrative embodiments, the carbonated beverage contains a sufficient amount of at least one diglyceride selected from a 2,3-diacylglycerol of the following formula:

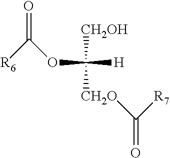

wherein each of R₆ and R₇ are independently a straight chain or branch chain, saturated or unsaturated, aliphatic hydrocarbon chain having at least 3 carbon atoms. According to certain illustrative embodiments, each of R₆ and R₇ are independently a straight chain or branch chain, saturated or unsaturated, aliphatic chain having at least 5 carbon atoms. According to certain illustrative embodiments, each of R₆ and R₇ are independently a straight chain or branch chain, saturated or unsaturated, aliphatic chain having from 6 to 12 carbon atoms. According to certain illustrative embodiments, each of R₆ and R₇ are independently a straight chain or branch chain, saturated or unsaturated, aliphatic chain having from 13 to 21 carbon atoms. According to certain illustrative embodiments, each of R₆ and R₇ are independently straight chain or branch chain, saturated or unsaturated, aliphatic chain having from 22 to 28 carbon atoms.

According to illustrative embodiments, the carbonated beverage contains a sufficient amount of at least one diglyceride selected from a 1,3-diacylglycerol of the following formula:

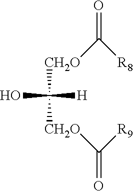

wherein each of R₈ and R₉ are independently a straight chain or branch chain, saturated or unsaturated, aliphatic hydrocarbon chain having at least 3 carbon atoms. According to certain illustrative embodiments, each of R₈ and R₉ are independently a straight chain or branch chain, saturated or unsaturated, aliphatic chain having at least 5 carbon atoms. According to certain illustrative embodiments, each of R₈ and R₉ are independently a straight chain or branch chain, saturated or unsaturated, aliphatic chain having from 6 to 12 carbon atoms. According to certain illustrative embodiments, each of R₈ and R₉ are independently a straight chain or branch chain, saturated or unsaturated, aliphatic chain having from 13 to 21 carbon atoms. According to certain illustrative embodiments, each of R₈ and R₉ are independently straight chain or branch chain, saturated or unsaturated, aliphatic chain having from 22 to 28 carbon atoms.

According to certain illustrative embodiments, the amount of the gas reducing additive included in the reduced sugar carbonated beverage composition is from about 0.1 ppm to about 20 ppm, or from about 0.2 ppm to about 20 ppm, or from about 0.3 ppm to about 20 ppm, or from about 0.4 ppm to about 20 ppm, or from about 0.5 ppm to about 20 ppm, or from about 0.6 ppm to about 20 ppm, or from about 0.7 ppm to about 20 ppm, or from about 0.8 ppm to about 20 ppm, or from about 0.9 ppm to about 20 ppm, or from about 1 ppm to about 20 ppm, or from about 2 ppm to about 20 ppm, or from about 3 ppm to about 20 ppm, or from about 4 ppm to about 20 ppm, or from about 5 ppm to about 20 ppm, or from about 10 ppm to about 20 ppm, or from about 15 ppm to about 20 ppm, from about 0.5 ppm to about 20 ppm, or from about 0.5 to about 19 ppm, or from about 0.5 ppm to about 18 ppm, or from about 0.5 ppm to about 16 ppm, or from about 0.5 ppm to about 15 ppm, or from about 0.5 ppm to about 14 ppm, or from about 0.5 to about 13 ppm, or from about 0.5 ppm to about 12 ppm, or from about 0.5 ppm to about 11 ppm, or from about 0.5 ppm to about 10 ppm, or from about 0.5 to about 9 ppm, or from about 0.5 to about 8 ppm, or from about 0.5 to about 7 ppm, or from about 0.5 ppm to about 6 ppm, or from about 0.5 ppm to about 5 ppm, or from about 0.5 ppm to about 4 ppm, or from about 0.4 ppm to about 3 ppm, or from about 0.5 ppm to about 2 ppm, or from about 0.5 ppm to about 1 ppm, or any other amount within the range of about 0.1 ppm to about 20 ppm.

The beverage composition includes at least one flavor. Without limitation, and only by way of illustration, suitable flavors include, a cola flavorant, a tea flavorant, a caramel flavorant, a coffee flavorant, a citrus flavorant (e.g. a lemon flavorant, a lime flavorant, an orange flavorant, a grapefruit flavorant, a mandarin orange flavorant, a tangerine flavorant, or a combination of any of the foregoing), an herbal flavorant, a berry flavoring (e.g., a flavorant derived from one or more of Barbados cherry, bearberry, blackberry, blueberry, boysenberry, cherry, choke cherry, cloudberry, cranberry, current, date, dewberry, elderberry, grape, gooseberry, huckleberry, loganberry, olallieberry, mulberry, raisin, plains berry, prairie berry, raspberry, saskatoon berry, salmonberry, seabuckthorn berry, sloe berry, strawberry, thimbleberry, thornberry, wineberry, whortleberry, or a combination of any of the foregoing), a botanical flavorant (e.g. one or more flavors derived from a part of a plant other than the fruit, including flavors derived from essential oils and extracts of nuts, bark, roots and leaves along with synthetically prepared flavors made to simulate botanical flavors derived from natural sources), and mixtures thereof.

Full sugar or reduced sugar carbonated beverages of the present disclosure may include at least one nutritive sweetener. Without limitation, and only by way of illustration, suitable nutritive sweeteners include sucrose, fructose, glucose, high fructose corn syrup, corn syrup, xylose, arabinose, rhamnose, erythritol, xylitol, mannitol, sorbitol, isomaltulose, inositol, allulose, tagalose, trehalose, and combinations thereof.

Reduced sugar and zero sugar carbonated beverages of the present disclosure include at least one non-nutritive sweetener that either partially (reduced sugar beverages) or wholly (zero sugar beverages) replaces the nutritive sweetener in the carbonated beverage composition.

According to certain illustrative embodiments, the non-nutritive sweeteners that may be used in the reduced sugar and/or zero sugar carbonated beverages are selected from natural non-nutritive sweeteners, synthetic non-nutritive sweeteners, and combinations thereof.

Without limitation, and only by way of illustration, suitable synthetic non-nutritive sweeteners that may be included in the reduced sugar or zero sugar carbonated beverages maybe selected from acesulfame K, advantame, aspartame, cyclamate, neotame, neohesperidin dihydrochalcone, saccharin, sucrolose and combinations thereof.

Without limitation, and only by way of illustration, suitable natural non-nutritive sweeteners include steviol glycosides selected from stevioside, rebaudioside A, rebaudioside B, rebaudioside C, rebaudioside D, rebaudioside E, rebaudioside F, rebaudioside G, rebaudioside H, rebaudioside I, rebaudioside J, rebaudioside K, rebaudioside L, rebaudioside M, rebaudioside N, rebaudioside O, dulcoside A, dulcoside B, rubusoside, and combinations thereof, mogrol glycosides selected from mogroside I, mogroside II, mogroside III, mogroside IV, mogroside V, isomogroside V, 11-oxomogroside, siamenoside I and combinations thereof, naringin dihydrochalcone, Luo Han Guo Extract, Swingle Extract, brazzein, cellobiose, glycyrrhizic acid, monatin, psicose, stevioside, thaumatin, trilobatin, and combinations thereof.

According to certain illustrative embodiments, the non-nutritive sweetener present in the reduced sugar carbonated beverage is aspartame and the amount of the gas reducing additive included in the reduced sugar carbonated beverage is in the range of about 0.5 ppm to about 5 ppm.

According to certain illustrative embodiments, the non-nutritive sweetener present in the reduced sugar carbonated beverage is acesulfame K and the amount of the gas reducing additive included in the reduced sugar carbonated beverage is in the range of about 0.5 ppm to about 7 ppm.

According to certain illustrative embodiments, the non-nutritive sweetener present in the reduced sugar carbonated beverage is stevia and the amount of the gas reducing additive included in the reduced sugar carbonated beverage is in the range of about 0.5 ppm to about 16 ppm.

According to certain illustrative embodiments, the non-nutritive sweetener present in the reduced sugar carbonated beverage is sucralose and the amount of the gas reducing additive included in the reduced sugar carbonated beverage is in the range of about 0.5 ppm to about 8 ppm.

According to certain illustrative embodiments, the non-nutritive sweetener present in the reduced sugar carbonated beverage is a combination of aspartame and acesulfame K and the amount of the gas reducing additive included in the reduced sugar carbonated beverage is in the range of about 0.5 ppm to about 10 ppm.

According to certain illustrative embodiments, the non-nutritive sweetener present in the reduced sugar carbonated beverage is a combination of acesulfame K and sucralose and the amount of the gas reducing additive included in the reduced sugar carbonated beverage is in the range of about 0.5 ppm to about 12 ppm.

According to certain embodiments, beverages include carbonated beverages. Carbonated beverages include all beverages and drinks that include carbon dioxide dissolved in a liquid, such as water. Without limitation, carbonated beverages include bubbly waters, fizzy waters, champagne, carbonated sodas, carbonated soft drinks (eg, Coca-Cola, Pepsi, Dr. Pepper, Mountain Dew, Sprite, 7-Up, ginger-ale, root beer, etc, . . . ), carbonated fruit drinks, carbonated fruit juices, carbonated vegetable juices, carbonated fruit/vegetable juices, carbonated coffees, carbonated dairy drinks, carbonated dairy alternative drinks (ie, plant-based dairy alternative drinks) carbonated energy drinks, carbonated sports drinks, flavored sparkling waters (eg, blackberry, blueberry, cranberry, raspberry, black raspberry, lemon-lime, orange, grape, cherry, strawberry, watermelon, coconut, guava, kiwi, mango, papaya, passion fruit, pineapple, etc), flavored seltzer waters, carbonated mineral waters, sparkling teas, sparkling tonics, and sparkling wines.

Additionally disclosed is a method for reducing gas loss from a beverage. According to certain illustrative embodiments, the method is directed to reducing gas loss from a carbonated beverage. According to further illustrative embodiments, the method is directed to reducing gas loss from a reduced sugar or zero sugar carbonated beverage.

According to certain illustrative embodiments, the method is directed to preventing gas loss from a beverage. According to certain illustrative embodiments, the method is directed to preventing gas loss from a reduced sugar or zero sugar carbonated beverage.

The method of reducing or preventing gas loss from a reduced sugar or zero sugar carbonated beverage comprises adding a gas loss reducing additive to a beverage base or to a carbonated beverage in an amount sufficient to reduce the loss of dissolved carbon dioxide gas from the water medium of the carbonated beverage.

Encapsulation of the carbon dioxide gas bubbles present within the carbonated beverage medium prevents the gas bubbles from agglomerating into larger bubbles. The encapsulated bubbles off each other thereby having a longer residence time in the beverage medium. This reduces the amount of foam formation that is commonly associated with reduced sugar carbonated beverages. The reduced foam formation and increased residence time of the carbon dioxide gas bubbles in the beverage also increases the overall carbonated mouthfeel and perception.

The gas reducing additive may be used in a carbonated beverage composition in any amount sufficient to result in a reduction of the loss carbon dioxide gas from the carbonated beverage composition as compared to the amount of loss of carbon dioxide gas under the same experimental, manufacturing, and/or consumption conditions from another carbonated beverage having the same carbonated beverage composition but without the inclusion of the gas reducing additive.

The carbonated beverage of the present disclosure may be a ready-to-drink beverage that is directly consumable without any dilution. The carbonated beverage is charged into a suitable container, for example, a bottle, can, or pack. According to certain embodiments, the carbonated beverage is charged into a bottle having a resealable cap. Non-limiting examples of a bottle having a resealable cap include molded bottles containing as a main component polyethylene terephthalate, aluminum, steel, and like metal bottle cans.

Further disclosed is a beverage production and bottling method for the disclosed carbonated beverage. The carbonated beverage is prepared by mixing together water, at least one sweetener component, and at least one flavor to prepare a beverage base. Additional components such as acidifiers, antioxidants, coloring agents, preservatives, and the like, are added to the beverage base. Carbon dioxide gas is then injected into the beverage base by routine techniques and using carbonation equipment known in the art to provide a carbonated beverage having a desired gas pressure. The gas loss reducing additive may be added to the beverage base prior to the injection of the carbon dioxide gas, or it may be added to the carbonated beverage.

The method for filling a bottle with a desired amount of the carbonated beverage composition comprising a beverage base and the gas reducing additive includes charging a desired amount of the beverage composition into the bottle and sealing the bottle with a resealable closure such as a cap.

In addition to increasing the retention of the dissolved carbon dioxide gas within the beverage, the inclusion of the gas loss reducing additive also improves the mouthfeel of the reduced sugar or zero sugar carbonated beverage such that the mouthfeel approximates or closely mimics the mouthfeel of a full sugar carbonated beverage. The term “mouthfeel” or “mouth feel” refers to the complexity of perceptions or physical sensations experienced or felt in the mouth that are created or influenced by food and beverages, or compositions added to food or beverages. Mouthfeel may refer to textures that come into contact with the cheeks, lips, tongue, roof of the mouth, teeth, gums, or throat. Mouthfeel is considered to be distinct from taste/flavor, but is considered to have an equal or even greater impact on a person's enjoyment or preference for certain foods over others. Typical mouthfeel descriptors used to describe perceived sensations include acidity (metallic, citrusy, bright), astringency, burning, cold, cooling, hot, warm, warming, carbonation (fizzy, foamy), cohesiveness, density (close, airy), dryness (arid, scorched), fracturability, graininess (grittiness, particulate, powdery, dusty, grainy, chalky, sandy), gumminess (chewy, tough), hardness (crunchy, soft, spongy), heaviness (full, weighty, thick), irritation (biting, numbing, prickly, stinging, tingling, lingering), juiciness, mouth coating (fatty, oily, buttery), roughness (abrasive, textured), slipperiness (slimy, stringy), smoothness (satiny, velvety), stickiness, uniformity (even, uneven) and viscosity (full-bodied, light-bodied).

According to certain illustrative embodiments, disclosed is the use of an additive for reducing gas loss from a beverage.

According to certain illustrative embodiments, disclosed is the use of an additive for reducing the loss of gas from a carbonated beverage.

According to certain illustrative embodiments, disclosed is the use of an additive for reducing the loss of gas from a reduced sugar or zero sugar carbonated beverage.

The use of at least one glyceride in a carbonated beverage to reduce the loss of carbon dioxide gas from the beverage may include one or more glycerides that vary in their chemical structure based on the number of carbon atoms in the fatty acid group, the different degrees of unsaturation of the fatty acid groups and the different configurations of the fatty acid groups. The fatty acids useful include short chain fatty acids having an aliphatic chain with 5 or less carbon atoms, medium chain fatty acids having an aliphatic chain with 6 to 12 carbon atoms, long chain fatty acids having an aliphatic chain with 13 to 21 carbon atoms, and very long chain fatty acids having an aliphatic chain with 22 or more carbon atoms. The aliphatic chains of the fatty acids may be saturated (no carbon-carbon double bonds in the aliphatic chain) or unsaturated (having one or more carbon-carbon double bonds in the aliphatic chain). The unsaturated fatty acids useful in the present disclosure may include both cis and trans configurations.

According to illustrative embodiments, the use of at least one glyceride in a carbonated beverage to reduce the loss of carbon dioxide gas from the beverage comprises the use of a sufficient amount of at least one monoglyceride selected from a 1-acylglycerol of the following formula:

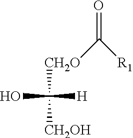

wherein R₁ a straight chain or branch chain, saturated or unsaturated, aliphatic hydrocarbon chain having at least 3 carbon atoms. According to certain illustrative embodiments, R₁ is a straight chain or branch chain, saturated or unsaturated, aliphatic chain having at least 5 carbon atoms. According to certain illustrative embodiments, R₁ is a straight chain or branch chain, saturated or unsaturated, aliphatic chain having from 6 to 12 carbon atoms. According to certain illustrative embodiments, R₁ is a straight chain or branch chain, saturated or unsaturated, aliphatic chain having from 13 to 21 carbon atoms. According to certain illustrative embodiments, R₁ is a straight chain or branch chain, saturated or unsaturated, aliphatic chain having from 22 to 28 carbon atoms.

According to illustrative embodiments, the use of at least one glyceride in a carbonated beverage to reduce the loss of carbon dioxide gas from the beverage comprises the use of a sufficient amount of at least one monoglyceride selected from a 2-acylglycerol of the following formula:

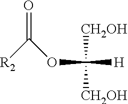

wherein R₂ a straight chain or branch chain, saturated or unsaturated, aliphatic hydrocarbon chain having at least 3 carbon atoms. According to certain illustrative embodiments, R₂ is a straight chain or branch chain, saturated or unsaturated, aliphatic chain having at least 5 carbon atoms. According to certain illustrative embodiments, R₂ is a straight chain or branch chain, saturated or unsaturated, aliphatic chain having from 6 to 12 carbon atoms. According to certain illustrative embodiments, R₂ is a straight chain or branch chain, saturated or unsaturated, aliphatic chain having from 13 to 21 carbon atoms. According to certain illustrative embodiments, R₂ is a straight chain or branch chain, saturated or unsaturated, aliphatic chain having from 22 to 28 carbon atoms.

According to illustrative embodiments, the use of at least one glyceride in a carbonated beverage to reduce the loss of carbon dioxide gas from the beverage comprises the use of a sufficient amount of at least one monoglyceride selected from a 3-acylglycerol of the following formula:

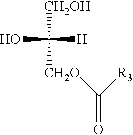

wherein R₃ a straight chain or branch chain, saturated or unsaturated, aliphatic hydrocarbon chain having at least 3 carbon atoms. According to certain illustrative embodiments, R₃ is a straight chain or branch chain, saturated or unsaturated, aliphatic chain having at least 5 carbon atoms. According to certain illustrative embodiments, R₃ is a straight chain or branch chain, saturated or unsaturated, aliphatic chain having from 6 to 12 carbon atoms. According to certain illustrative embodiments, R₃ is a straight chain or branch chain, saturated or unsaturated, aliphatic chain having from 13 to 21 carbon atoms. According to certain illustrative embodiments, R₃ is a straight chain or branch chain, saturated or unsaturated, aliphatic chain having from 22 to 28 carbon atoms.

According to illustrative embodiments, the use of at least one glyceride in a carbonated beverage to reduce the loss of carbon dioxide gas from the beverage comprises the use of a sufficient amount of at least one diglyceride selected from a 1,2-diacylglycerol of the following formula:

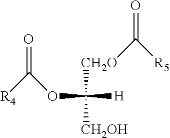

wherein each of R₄ and R₅ are independently a straight chain or branch chain, saturated or unsaturated, aliphatic hydrocarbon chain having at least 3 carbon atoms. According to certain illustrative embodiments, each of R₄ and R₅ are independently a straight chain or branch chain, saturated or unsaturated, aliphatic chain having at least 5 carbon atoms. According to certain illustrative embodiments, each of R₄ and R₅ are independently a straight chain or branch chain, saturated or unsaturated, aliphatic chain having from 6 to 12 carbon atoms. According to certain illustrative embodiments, each of R₄ and R₅ are independently a straight chain or branch chain, saturated or unsaturated, aliphatic chain having from 13 to 21 carbon atoms. According to certain illustrative embodiments, each of R₄ and R₅ are independently straight chain or branch chain, saturated or unsaturated, aliphatic chain having from 22 to 28 carbon atoms.

According to illustrative embodiments, the use of at least one glyceride in a carbonated beverage to reduce the loss of carbon dioxide gas from the beverage comprises the use of a sufficient amount of at least one diglyceride selected from a 2,3-diacylglycerol of the following formula:

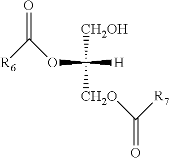

wherein each of R₆ and R₇ are independently a straight chain or branch chain, saturated or unsaturated, aliphatic hydrocarbon chain having at least 3 carbon atoms. According to certain illustrative embodiments, each of R₆ and R₇ are independently a straight chain or branch chain, saturated or unsaturated, aliphatic chain having at least 5 carbon atoms. According to certain illustrative embodiments, each of R₆ and R₇ are independently a straight chain or branch chain, saturated or unsaturated, aliphatic chain having from 6 to 12 carbon atoms. According to certain illustrative embodiments, each of R₆ and R₇ are independently a straight chain or branch chain, saturated or unsaturated, aliphatic chain having from 13 to 21 carbon atoms. According to certain illustrative embodiments, each of R₆ and R₇ are independently straight chain or branch chain, saturated or unsaturated, aliphatic chain having from 22 to 28 carbon atoms.

According to illustrative embodiments, the use of at least one glyceride in a carbonated beverage to reduce the loss of carbon dioxide gas from the beverage comprises the use of a sufficient amount of at least one diglyceride selected from a 1,3-diacylglycerol of the following formula:

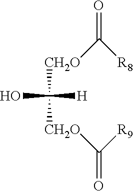

wherein each of R₈ and R₉ are independently a straight chain or branch chain, saturated or unsaturated, aliphatic hydrocarbon chain having at least 3 carbon atoms. According to certain illustrative embodiments, each of R₈ and R₉ are independently a straight chain or branch chain, saturated or unsaturated, aliphatic chain having at least 5 carbon atoms. According to certain illustrative embodiments, each of R₈ and R₉ are independently a straight chain or branch chain, saturated or unsaturated, aliphatic chain having from 6 to 12 carbon atoms. According to certain illustrative embodiments, each of R₈ and R₉ are independently a straight chain or branch chain, saturated or unsaturated, aliphatic chain having from 13 to 21 carbon atoms. According to certain illustrative embodiments, each of R₈ and R₉ are independently straight chain or branch chain, saturated or unsaturated, aliphatic chain having from 22 to 28 carbon atoms.

### EXAMPLES

### Example 1—Preparation of Gas Loss Reducing Additive

TABLE 1

| Ingredient | Parts |
|---|---|
| Corn Maltodextrin | 300 |
| Starch sodium octenyl succinate | 75 |
| Gas loss reducing additive | 119 |
| Antioxidant | 3 |
| Salt Flavor | 3 |
| Water | 500 |
| Total | 1000 |

An illustrative gas loss reducing additive was prepared comprising a blend of C14-C18 and C16-C18 unsaturated alkyl (monoglycerides) and C14-C18 and C16-C18 unsaturated dialkyl glyceride (diglycerides). An emulsion was prepared by combining water, corn-derived maltodextrin and starch sodium octenyl succinate. The monodiglycerides, antioxidant (tocopherol) and salt flavor were added to the emulsion and mixed until these ingredients were dissolved. The emulsion was spray-dried to produce particles of the gas loss reducing additive.

### Comparative Example C2 and Examples 3-5

Table 2 shows reduced sugar cola beverage formulation having a 50% sugar reduction as compared to a 100% sugar cola beverage. The reduced sugar beverage formulations include the non-nutritive sweeteners aspartame, acesulfame k, sucralose, and steviol glycoside as replacements for the sugar in the beverage formulation, and varying amounts of the gas loss reducing additive.

TABLE 2

| | C2 | 3 | 4 | 5 |
|---|---|---|---|---|
| | 100% | 50% Sugar | 50% Sugar | 50% Sugar |
| | Sugar | Reduction | Reduction | Reduction |
| Ingredient | g/liter | g/liter | g/liter | g/liter |
| Sugar | 108.2376 | 54.1188 | 54.1188 | 54.1188 |
| Benzoate | 0.06 | 0.06 | 0.06 | 0.06 |
| Cola color | 2 | 1.6 | 1.6 | 1.6 |
| fraction | | | | |
| Cola flavor | 3 | 2 | 2 | 2 |
| Water | 928.4724 | 963.1812 | 963.1812 | 963.1812 |
| Total | 1041.77 | 1020.96 | 1020.96 | 1020.96 |
| Aspartame | | 0.18 | | |
| Acesulfame k | | 0.08 | 0.19 | |
| Sucralose | | | 0.09 | |
| Steviol | | | | 0.15 |
| Glycoside | | | | |
| Gas Loss | | 0.006 | 0.005 | 0.008 |
| Reducing | | | | |
| Additive | | | | |

| | | |
|---|---|---|
| Solids | 108.2976 | 54.1788 |
| Brix | 10.4 | 5.31 |
| CO₂ | 4.3 | 4.3 |

### Examples 6-9

Table 3 shows reduced sugar cola beverage formulation having a 60% sugar reduction as compared to a 100% sugar cola beverage. The reduced sugar beverage formulations include the non-nutritive sweeteners aspartame, acesulfame k, sucralose, and steviol glycoside as replacements for the sugar in the beverage formulation, and varying amounts of the gas loss reducing additive.

TABLE 3

| | 6 | 7 | 8 | 9 |
|---|---|---|---|---|
| | 60% Sugar | 60% Sugar | 60% Sugar | 60% Sugar |
| | Reduction | Reduction | Reduction | Reduction |
| Ingredient | g/liter | g/liter | g/liter | g/liter |
| Sugar | 54.1188 | 43.29504 | 43.29504 | 43.29504 |
| Benzoate | 0.06 | 0.06 | 0.06 | 0.06 |
| Cola color | 1.6 | 1.6 | 1.6 | 1.6 |
| fraction | | | | |
| Cola flavor | 2 | 2 | 2 | 2 |
| Water | 963.1812 | 969.83496 | 969.83496 | 969.83496 |
| Total | 1020.96 | 1016.79 | 1016.79 | 1016.79 |
| Aspartame | | 0.22 | | |
| Acesulfame k | | 0.1 | 0.2 | |
| Sucralose | | | 0.12 | |
| Steviol | 0.15 | | | 0.18 |
| Glycoside | | | | |
| Gas Loss | 0.008 | 0.006 | 0.0055 | 0.008 |
| Reducing | | | | |
| Additive | | | | |

| | |
|---|---|
| Solids | 43.35504 |
| Brix | 4.27 |
| CO₂ | 4.3 |

### Examples 10-12

Table 4 shows reduced sugar cola beverage formulation having a 70% sugar reduction as compared to a 100% sugar cola beverage. The reduced sugar beverage formulations include the non-nutritive sweeteners aspartame, acesulfame k, sucralose, and steviol glycoside as replacements for the sugar in the beverage formulation, and varying amounts of the gas loss reducing additive.

TABLE 4

| | 10 | 11 | 12 |
|---|---|---|---|
| | 70% Sugar | 70% Sugar | 70% Sugar |
| | Reduction | Reduction | Reduction |
| Ingredient | g/liter | g/liter | g/liter |
| Sugar | 32.47128 | 32.47128 | 32.47128 |
| Benzoate | 0.06 | 0.06 | 0.06 |
| Cola color | 1.6 | 1.6 | 1.6 |
| fraction | | | |
| Cola flavor | 2 | 2 | 2 |
| Water | 976.44872 | 976.44872 | 976.44872 |
| Total | 1012.58 | 1012.58 | 1012.58 |
| Aspartame | 0.3 | 0.32 | |
| Acesulfame k | 0.12 | | |
| Sucralose | | 0.14 | |
| Steviol | | | 0.236 |
| Glycoside | | | |
| Gas Loss | 0.0082 | 0.0058 | 0.015 |
| Reducing | | | |
| Additive | | | |

| | |
|---|---|
| Solids | 32.53128 |
| Brix | 3.21 |
| CO₂ | 4.3 |

### Examples 13-15

Table 5 shows reduced sugar cola beverage formulation having a 80% sugar reduction as compared to a 100% sugar cola beverage. The reduced sugar beverage formulations include the non-nutritive sweeteners aspartame, acesulfame k, sucralose, and steviol glycoside as replacements for the sugar in the beverage formulation, and varying amounts of the gas loss reducing additive.

TABLE 5

| | 13 | 14 | 15 |
|---|---|---|---|
| | 80% Sugar | 80% Sugar | 80% Sugar |
| | Reduction | Reduction | Reduction |
| Ingredient | g/liter | g/liter | g/liter |
| Sugar | 21.64752 | 21.64752 | 21.64752 |
| Benzoate | 0.06 | 0.06 | 0.06 |
| Cola color | 1.6 | 1.6 | 1.6 |
| fraction | | | |
| Cola flavor | 2 | 2 | 2 |
| Water | 983.13248 | 983.13248 | 983.13248 |
| Total | 1008.44 | 1008.44 | 1008.44 |
| Aspartame | 0.35 | 0.36 | |
| Acesulfame k | 0.14 | | |
| Sucralose | | 0.18 | |
| Steviol | | | 0.255 |
| Glycoside | | | |
| Gas Loss | 0.0082 | 0.0058 | 0.018 |
| Reducing | | | |
| Additive | | | |

| | |
|---|---|
| Solids | 21.70752 |
| Brix | 2.15 |
| CO₂ | 4.3 |

### Examples 16-18

Table 6 shows reduced sugar cola beverage formulation having a 90% sugar reduction as compared to a 100% sugar cola beverage. The reduced sugar beverage formulations include the non-nutritive sweeteners aspartame, acesulfame k, sucralose, and steviol glycoside as replacements for the sugar in the beverage formulation, and varying amounts of the gas loss reducing additive.

TABLE 6

| | 16 | 17 | 18 |
|---|---|---|---|
| | 90% Sugar | 90% Sugar | 90% Sugar |
| | Reduction | Reduction | Reduction |
| Ingredient | g/liter | g/liter | g/liter |
| Sugar | 10.82376 | 10.82376 | 10.82376 |
| Benzoate | 0.06 | 0.06 | 0.06 |
| Cola color | 1.6 | 1.6 | 1.6 |
| fraction | | | |
| Cola flavor | 2 | 2 | 2 |
| Water | 989.74624 | 989.74624 | 989.74624 |
| Total | 1004.23 | 1004.23 | 1004.23 |
| Aspartame | 0.37 | 0.36 | |
| Acesulfame k | 0.143 | | |
| Sucralose | | 0.187 | |
| Steviol | | | 0.278 |
| Glycoside | | | |
| Gas Loss | 0.0082 | 0.0058 | 0.018 |
| Reducing | | | |
| Additive | | | |

| | |
|---|---|
| Solids | 10.8838 |
| Brix | 1.09 |
| CO₂ | 4.3 |

### Examples 19-21

Table 7 shows reduced sugar cola beverage formulation having a 50% sugar reduction as compared to a 100% sugar cola beverage. The reduced sugar beverage formulations include the non-nutritive sweeteners aspartame, acesulfame k, sucralose, and steviol glycoside as replacements for the sugar in the beverage formulation, and varying amounts of the gas loss reducing additive.

TABLE 7

| | 19 | 20 | 21 |
|---|---|---|---|
| | 100% Sugar | 100% Sugar | 100% Sugar |
| | Reduction | Reduction | Reduction |
| Ingredient | g/liter | g/liter | g/liter |
| Sugar | 0 | 0 | 0 |
| Benzoate | 0.06 | 0.06 | 0.06 |
| Cola color | 1.6 | 1.6 | 1.6 |
| fraction | | | |
| Cola flavor | 2 | 2 | 2 |
| Water | 996.36 | 996.36 | 996.36 |
| Total | 1004.23 | 1004.23 | 1004.23 |
| Aspartame | 0.37 | 0.33 | |
| Acesulfame k | 0.16 | | |
| Sucralose | | 0.18 | |
| Steviol | | | 0.295 |
| Glycoside | | | |
| Gas Loss | 0.0082 | 0.0058 | 0.018 |
| Reducing | | | |
| Additive | | | |

| | |
|---|---|
| Solids | 0.06 |
| Brix | 0.01 |
| CO₂ | 4.3 |

While the gas loss reducing additive, beverages including the gas loss reducing additive, and methods of reducing gas loss from a carbonated beverage have been described in connection with various illustrative embodiments, it is to be understood that other similar embodiments may be used or modifications and additions may be made to the described embodiments for performing the same function. Furthermore, the various illustrative embodiments may be combined to produce the desired results. Therefore, the gas loss reducing additive, beverages including the gas loss reducing additive, and methods of reducing gas loss from a carbonated beverage should not be limited to any single embodiment, but rather construed in breadth and scope in accordance with the recitation of the appended claims. It will be understood that the embodiments described herein are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

1. A method for reducing gas loss from a carbonated beverage, the method comprising adding at least one glyceride to the carbonated beverage in amount sufficient to encapsulate gas bubbles present within the carbonated beverage.

2. The method of claim 1, wherein the encapsulation of the gas bubbles results in an increase in the surface tension of the gas bubbles.

3. The method of claim 1, wherein the carbonated beverage is a reduced sugar carbonated beverage or a zero sugar carbonated beverage.

4. The method of claim 1, wherein the at least one glyceride is selected from the group consisting of monoglycerides, diglycerides and mixtures thereof.

5. The method of claim 4, wherein the at least one glyceride is a mixture of at least one monoglyceride and at least one diglyceride.

6. The method of claim 4, wherein the at least one monoglyceride is selected from a 1-acylglycerol of the following formula: 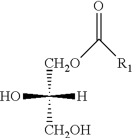
wherein R₁ a straight chain or branch chain, saturated or unsaturated, aliphatic hydrocarbon chain having at least 3 carbon atoms.

7. The method of claim 4, wherein the at least one monoglyceride is selected from a 2-acylglycerol of the following formula: 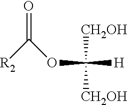
wherein R₂ a straight chain or branch chain, saturated or unsaturated, aliphatic hydrocarbon chain having at least 3 carbon atoms.

8. The method of claim 4, wherein the at least one monoglyceride is selected from a 3-acylglycerol of the following formula: 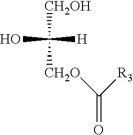
wherein R₃ a straight chain or branch chain, saturated or unsaturated, aliphatic hydrocarbon chain having at least 3 carbon atoms.

9. The method of claim 4, wherein the at least one diglyceride is selected from a 1,2-diacylglycerol of the following formula: 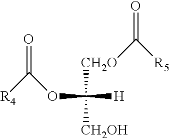
wherein each of R₄ and R₅ independently a straight chain or branch chain, saturated or unsaturated, aliphatic hydrocarbon chain having at least 3 carbon atoms.

10. The method of claim 4, wherein the at least one diglyceride is selected from a 2,3-diacylglycerol of the following formula: 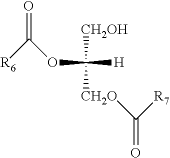
wherein each of R₆ and R₇ independently a straight chain or branch chain, saturated or unsaturated, aliphatic hydrocarbon chain having at least 3 carbon atoms.

11. A carbonated beverage comprising a beverage base and at least one glyceride in an amount sufficient to encapsulate gas bubbles present within the carbonated beverage.

12. The carbonated beverage of claim 11, wherein the carbonated beverage is a reduced sugar beverage.

13. The carbonated beverage of claim 11, wherein the carbonated beverage is a zero sugar beverage.

14. The carbonated beverage of claim 11, wherein the at least one glyceride is selected from the group consisting of monoglycerides, diglycerides and mixtures thereof.

15. The carbonated beverage of claim 14, wherein the at least one glyceride is a mixture of at least one monoglyceride and at least one diglyceride.
